(19) United States
(12) Patent Application Publication
(10) Pub. No.: US 2026/0295427 A1
(43) Pub. Date: Oct. 1, 2026

(54) RESPONSIVE AI TEAMMATE

(71) Applicant: Sony Interactive Entertainment Inc., Tokyo (JP)

(72) Inventors: Syrsha Harvey, San Francisco, CA (US); Dilip Krishnamoorthi, Daly City, CA (US); Victoria Dorn, Hayward, CA (US); Sijia Zhang, San Francisco, CA (US); Abigail Edwards, San Francisco, CA (US); Prajna Cheryl Peters, San Francisco, CA (US)

(73) Assignee: Sony Interactive Entertainment Inc., Tokyo (JP)

(21) Appl. No.: 19/090,201

(22) Filed: Mar. 25, 2025

(51) Int. Cl. A63F 13/67

(52) U.S. Cl. CPC A63F 13/67

(57) ABSTRACT

Systems and methods of executing an AI companion application in a game environment include uploading, by a system including a processor and a memory, a game to the game environment, launching the AI companion application, receiving a global game directive from a user where the global game directive establishes a goal of the user for the game, executing actions, by the system via the AI companion application, within the game environment in accordance with the global game directive, gathering implicit user gameplay information from user interactions in the game environment while the AI companion application executes the actions within the game environment in accordance with the global game directive, determining short-term directives based at least in part on the implicit user gameplay information, and modifying the actions of the AI companion application based at least in part on the short-term directives.

### BACKGROUND

The video game industry has expanded significantly such that users have virtually infinite options for video games and other media types for interaction. Example gaming platforms may be the Sony Playstation®, Sony Playstation2® (PS2), Sony Playstation3® (PS3), Sony Playstation3® (PS4), Sony Playstation3® (PS5), etc., each of which is sold in the form of a game console. As is well known, the game console is designed to connect to a monitor (usually a television) and enable user interaction through handheld controllers. The game console is designed with specialized processing hardware, including a CPU, a graphics synthesizer for processing intensive graphics operations, a vector unit for performing geometry transformations, and other glue hardware, firmware, and software. Online gaming is also possible, where a user can interactively play against or with other users over the Internet. Other gaming platforms may include Playstation® Portal and Playstation® VR2. Today's game console is not used just to play games, but are used as a computing device that can access the Internet to search for content, browse for multimedia downloads, shop online music, videos or movies, participate in multiplayer games, enter virtual words, etc. Thus, a community of users is accessing online media, and this community of users has powerful computing devices and versatile interfaces.

For some games, tutorials are included in many games that allow a user to see a “walkthrough” of a game, or the games include a help bot that provides the user with tips and tricks throughout the game. However, some users may wish to receive guidance without being given explicit instructions on how to win the game, as it may be more stimulating and satisfying when a user is able to play and win the game on his own.

Embodiments address these and other problems, individually or collectively.

### SUMMARY

Embodiments of the present invention provide methods, systems, and computer programs for executing an adaptive player matching application for interacting on a platform. Embodiments of the present disclosure provide artificial intelligence (AI) players that take direction from a human player and/or provide guidance during cooperative game play.

According to one embodiment, a method of executing an AI companion application in a game environment includes uploading, by a system including a processor and a memory, a game to the game environment, launching, by the system, the AI companion application, receiving, by the system, a global game directive from a user where the global game directive establishes a goal of the user for the game, executing actions, by the system via the AI companion application, within the game environment in accordance with the global game directive, gathering, by the system, implicit user gameplay information from user interactions in the game environment while the AI companion application executes the actions within the game environment in accordance with the global game directive, determining, by the system, short-term directives based at least in part on the implicit user gameplay information, and modifying the actions of the AI companion application based at least in part on the short-term directives.

The method may include various optional embodiments. Requesting the user feedback may occur at benchmark points within the game. The benchmark points may occur at at least one of in a lobby portion of the game, a pre-level point within the game, a post-level point within the game, and a predetermined pivot point within the game. The method may further include determining, by the system via the AI companion application, a user skill based on the analyzed implicit user gameplay information, determining, by the AI companion application, a complimentary skill, and modifying the actions of the AI companion application in accordance with the complimentary skill. The user skill may include an offensive skill, and the complimentary skill may include a defensive skill. Receiving the global game directive may include requesting the user to provide game preferences prior to engaging with a game and/or during profile creation. The implicit user gameplay information may be gathered from one or more inputs where the one or more inputs comprises time data information associated with one or more titles in the game environment, shopping cart information, social media information, and user search history information. The method may further include monitoring user interactions with the AI companion application in the game environment where modifying the actions of the AI companion application is further based at least in part on the monitored user interactions. In some embodiments, the system is connected to a network and the method further includes monitoring user interactions with the AI companion application in an offline environment. Modifying the actions of the AI companion application may be further based at least in part on the monitored user interactions where the offline environment is not connected to the network. The method may further include requesting user feedback at at least a predetermined time intervals in the game, and modifying the actions of the AI companion application based on the short-term directives and the user feedback.

According to another embodiment, a system includes one or more storage media storing instructions and one or more processors to execute the instructions causing the system to perform operations including uploading a game to the game environment, launching an AI companion application, receiving a global game directive from a user, wherein the global game directive establishes a goal of the user for the game, executing actions, via the AI companion application, within the game environment in accordance with the global game directive, gathering implicit user gameplay information from user interactions in the game environment while the AI companion application executes the actions within the game environment in accordance with the global game directive, determining short-term directives based at least in part on the implicit user gameplay information, and modifying the actions of the AI companion application based at least in part on the short-term directives.

The system may include various optional embodiments. Requesting the user feedback may occur at benchmark points within the game. The benchmark points may occur at at least one of in a lobby portion of the game, a pre-level point within the game, a post-level point within the game, and a predetermined pivot point within the game. The operations may further include determining, by the system via the AI companion application, a user skill based on the analyzed implicit user gameplay information, determining, by the AI companion application, a complimentary skill, and modifying the actions of the AI companion application in accordance with the complimentary skill. The user skill may include an offensive skill, and the complimentary skill may include a defensive skill. Receiving the global game directive may include requesting the user to provide game preferences prior to engaging with a game and/or during profile creation. The implicit user gameplay information may be gathered from one or more inputs where the one or more inputs comprises time data information associated with one or more titles in the game environment, shopping cart information, social media information, and user search history information. The operations may further include monitoring user interactions with the AI companion application in the game environment where modifying the actions of the AI companion application is further based at least in part on the monitored user interactions. The method may further include requesting user feedback at at least a predetermined time intervals in the game, and modifying the actions of the AI companion application based on the short-term directives and the user feedback.

According to another embodiment, one or more non-transitory computer-readable storage media store instructions that, upon execution by one or more processors of a system, cause the system to upload a game to the game environment, launch an AI companion application, receive a global game directive from a user, wherein the global game directive establishes a goal of the user for the game, execute actions, via the AI companion application, within the game environment in accordance with the global game directive, gather implicit user gameplay information from user interactions in the game environment while the AI companion application executes the actions within the game environment in accordance with the global game directive, determine short-term directives based at least in part on the implicit user gameplay information, and modify the actions of the AI companion application based at least in part on the short-term directives.

### BRIEF DESCRIPTION OF THE DRAWINGS

Features, embodiments, and advantages of the present disclosure are better understood when the following Detailed Description is read with reference to the accompanying drawings.

FIG. 1 illustrates a computer system, according to embodiments of the present disclosure.

FIG. 2 illustrates an example of a game environment, according to some embodiments of the present disclosure.

FIG. 3 illustrates an embodiment of a method generating an AI companion in a game environment, according to embodiments of the present disclosure.

FIG. 4 is a flowchart of a method for executing an AI companion application in a game environment, according to embodiments of the present disclosure.

FIG. 5 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

Embodiments of the present disclosure provide systems and methods for generating artificial intelligence (AI) players that take direction from a human player and/or provide guidance during cooperative game play. The AI companions as provided herein are able to assist a player with both long-term, overarching game play objectives in addition to short-term directives within the game. Both the long-term objectives and the short-term directives may be updated by the user. According to various embodiments, the AI companion verifies the directives throughout game play. A gaming system and environment for executing an AI companion application are further described herein.

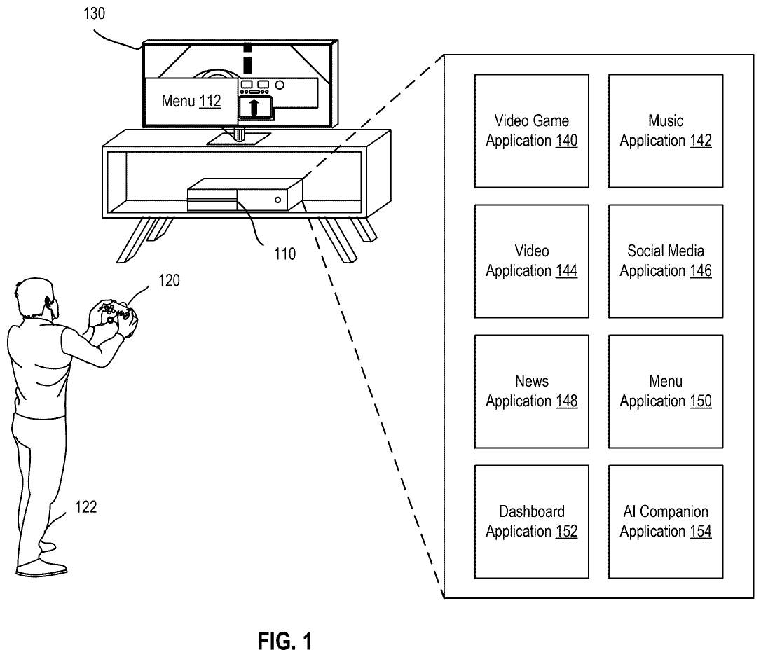

FIG. 1 illustrates a computer system, according to an embodiment of the present disclosure. As illustrated, the computer system 100 includes a video game console 110, a video game controller 120, and a display 130. Although not shown, the computer system may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). A user 122 operates the video game controller 120 to interact with the video game console 110. These interactions may include playing a video game presented on the display 130, interacting with a menu 112 presented on the display 130, and interacting with other applications of the video game console 110 (e.g., with media applications to stream media from an online content source or to play a media file from the local storage of the video game console 110).

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented form local storage of the video game console 110. Further, other applications can be likewise included in the video game console 110, such as a chat application. The availability of a video game application, media application, and/or other type of computer application to the user 122 via the video game console 110 can depend on a user identifier of the user 122 (e.g., upon a login to the video game console 110, the availability of the computer applications can depend on the user identifier used in the login). In addition, the video game console 110 includes a menu application 150, a dashboard application 152, and an AI companion application 154. The menu application 150 can present a home user interface (UI) in a GUI of the display 130. The dashboard application 152 can present an arrangement of interactive UI widgets in a dashboard page on the GUI.

The video game controller 120 is an example of an input device. The video game controller 120 may allow the user 122 to interact with one or more GUIs presented by the video game consol 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content (e.g., illustrated as a car race video game content) on the display 130. Upon user input from the video game controller 120 (e.g., a user push of a particular key or button), the rendering process also presents the menu 112. Additionally, or alternatively, the menu 112 may be presented as an initial landing page in response to a user powering-on the video game console 110 and/or waking the video game consol 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the menu application 150. Upon receiving a user input from the video game controller 120 requesting interactions with the menu 112, an underlying application (e.g., the menu application 150, the dashboard application 152, or the AI companion application 154 as applicable) supports such interactions by updating the menu 112 and launching any relevant application in the background or foreground. The user 122 can exit the menu 112 or automatically dismiss the menu 112 upon the launching of an application in the background or foreground. Upon exiting the menu 112 or the dismissal based on a background application launch, the user control changes from the underlying application to the video game application 140.

As described in more detail below, the dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple column element with textual or graphical description in each column, and the like. As described further, below, widgets may be presented with application information and/or dynamic content presented with the widget in a media library. For example, the dashboard application 152 may generate and/or present widgets associated with media applications, system applications and/or services, video game applications, or the like.

As described in more detail below, the dashboard application 152 may be executed via multiple avenues of ingress. For example, the dashboard application 152 may be executed by a pre-defined user interaction (e.g., via controller 120, a voice command from the user 122, activating and/or powering-on the video game consol 110 etc.) and/or by navigating one or more menus and/or sub-menus of the video game console 110 (e.g., menu 112).

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

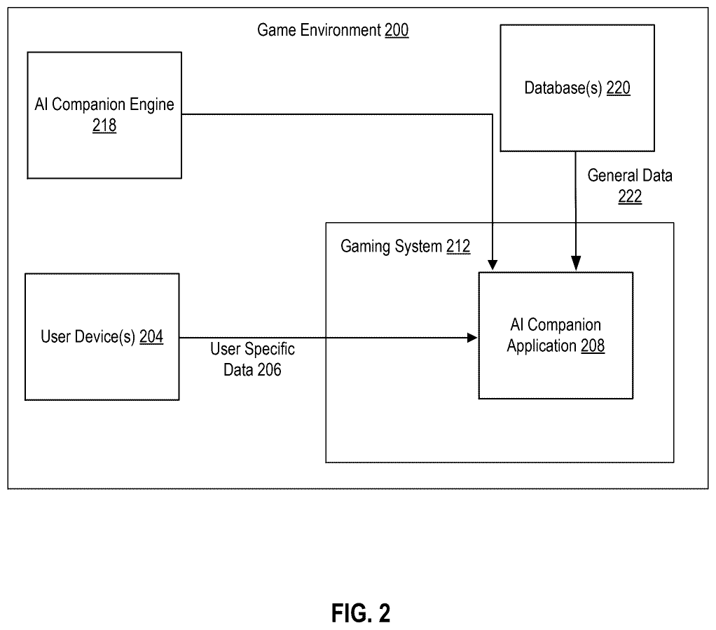

According to various embodiments, and as described in further detail below, the AI companion application 154 may be executed in a game (e.g., in a game environment). According to various embodiments, the AI companion application 154 is a local instance of the application and processing of inputs to the application occurs in a cloud-based environment, such as game environment 200 as described with respect to FIG. 2. In other embodiments, processing for the AI companion application 154 may be performed locally and/or via the cloud-based environment.

In electronic entertainment and video game systems, a user typically controls the behavior or actions of at least one character in a game environment. The user may interact with elements in the game, such as non-player characters whose actions are controlled by a set of rules. In some multi-player games, the users may all be human, or one may be a human and the others are computer-controlled. In other instances, there may be some other combination of human and computer players. The users may share one game system or may play on separate game systems connected by a communications network. The game system may also be part of a cloud-based game environment with multiple client controls and applications that may allow for interaction with the same.

For some games, tutorials are included in many games that allow a user to see a “walkthrough” of a game whereby the user is provided a step-by-step guide to playing the game. This may allow users to solve difficult problems or navigate advanced levels of the game. These tutorials effectively allow users to cheat by teaching them how to win the game without requiring them to make any substantive decisions or undertake any long-term exploration of the game environment during game play. Some users may wish to receive guidance without being given explicit instructions on how to win the game, as it may be more stimulating and satisfying when a user is able to play and win the game on his own.

Similarly, the computer-controlled characters that may be available in some games may allow users to learn from the behavior and actions of another character, but the computer-controlled characters lack intelligence. Thus, they are unable to adapt during game play and make decisions about when and how to assist or interact with the human user throughout the game. Accordingly, embodiments of the present disclosure provide artificial intelligence (AI) players that take direction from a human player and/or provide guidance during cooperative game play.

FIG. 2 illustrates an example of a game environment 200, according to some embodiments of the present disclosure. The game environment 200 may include at least a user device(s) 204, a gaming system 212, a database(s) 220, and an AI companion engine 218. The gaming system 212 can receive user specific data 206 from the user device 204. The gaming system 212 may also receive general data 222 from a database 220, to be described in further detail below. The AI companion engine 218 of the gaming system 212 generates an AI companion according to embodiments of the present disclosure. The AI companion engine 218 may be executed on a cloud-based server or the like. Each user device 204 runs a local instance of an AI companion application 208, such as the AI companion application 154 as described with respect to FIG. 1.

According to various embodiments, a database 220 can include general data 222 that supports system operations, game mechanism, and user engagement. For example, the database 220 can include game environment data, such as in-game world states, weather conditions, and dynamically changing elements like non-playable character (NPC) behavior or item spawn locations. The database 220 can include general user engagement metrics, such as average time spent on different game modes, popular levels or maps, and frequency of activity across various game features. The general user engagement metrics can be used to identify patterns in user behavior, such as which modes are most engaging or which areas of the game require balancing or improvement. The database 220 can also include game performance metrics, such as frame rates, load times, crash log, and latency statistics, which are critical for optimizing the technical aspects of the game and ensuring smooth gameplay. The database 220 can include inventory data, such as available in-game items, skins, or vehicles, as well as data on how frequently these items are used or unlocked by players. The database 220 can include event participation data, such as the number of players joining seasonal or time-limited events, their completion rates, and the outcomes of these events. The database 220 can also include leaderboard ranking and information for competitive or cooperative play, such as player skill ratings, connection quality, and regional-based preferences.

The database 220 can include user-specific data such as personal information, account details, subscription tiers, playtime statistics, friend lists, purchase history, and feedback provided by the user. The database 220 can also include user profile data such as gaming preferences like favorite genre, difficulty levels, unlocked achievements, skill level, in-game behavior, and avatar customization. The database 220 can further include comprehensive data such as game-specific data, content data, usage metrics, content recommendation data, community and social data, system data, and cross-platform data.

The database 220 can be embedded directly within the gaming console or system and stored on a local hard drive or solid-state drive. The gaming system 212 can communicate with the database 220 using an application programing interface (API) or file system integrations. Additionally, the one or more databases 220 can be hosted externally, such as on cloud servers. Cloud databased can communicate with the gaming system via internet protocols, such as RESTful APIs or WebSocket connections, providing real-time updates and synchronization. Additionally, hybrid setups are possible, where certain data (e.g., critical game files) is stored locally, while dynamic data (e.g., live game stats) resides in the cloud. The database 220 can also be integrated into third party services, such as gaming networks (e.g., PlayStation Network or Xbox Live). These external databases communicate with the gaming system through secure authentication protocols and encrypted data streams to ensure privacy and integrity. Furthermore, certain gaming systems may utilize edge computing, where smaller, distributed databases are located closer to the end user to reduce latency for high-performance scenarios like competitive gaming. The gaming system 212 can interact with the databases 220 through middleware or game engines which provide structured pathways for database queries and responses.

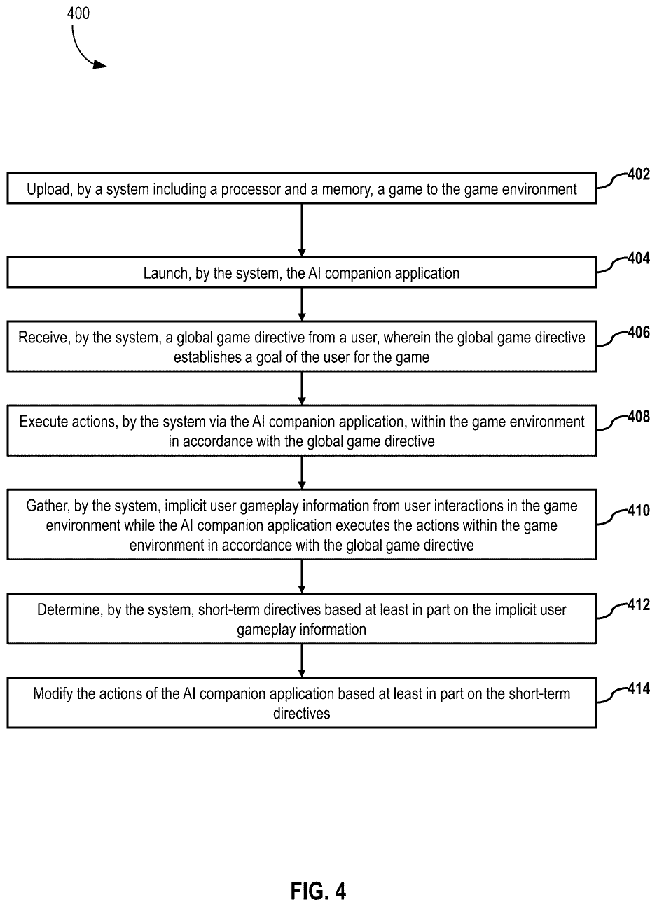

According to various embodiments, the AI companion engine 218 generates an AI companion to assist the user associated with the user device 204 with both long-term, overarching game play objectives in addition to short-term directives within the game environment 200 (e.g., within a game being executed within the game environment 200). Both the long-term objectives and the short-term directives may be updated by the user. According to various embodiments, the AI companion verifies the directives throughout game play, to be described with respect to FIG. 4 and process 400 in further detail below.

According to various embodiments, the ML model of the of the AI companion engine 218 is trained to be capable of processing natural language descriptions. The natural language training input may be part of a plurality of inputs. The natural language input can be processed by the ML model for generating outputs such as an AI companion. To guide the training process, the natural language input may include ground truth information. The ground truth information may be further validated against the outputs generated by the ML model, according to various embodiments, for finding discrepancies and refining the ML model. The ML model may be iteratively refined via a feedback loop and additional training cycles.

According to various embodiments of the present disclosure, the ML model of the AI companion engine 218 may receive feedback from the user device 204 for updating and training the ML model. For example, in response to the user feedback, the ML model may modify the predicted user preferences. For example, when user gameplay diverges from typical gameplay behavior, the ML model may recognize this change in behavior and adapt to accommodate new behaviors. Furthermore, the ML model may generate inquiries to determine whether the predicted user preferences are still accurate or whether the predicted user preferences need to be updated. The ML model may be updated in response to feedback and/or in response to identifying a change in user behavior. The ML model may be updated continuously and/or at predetermined intervals or as new inputs are received for training the ML model. Once the training process achieves a satisfactory level of accuracy and consistency, the ML model may be executed as part of the AI companion engine 218.

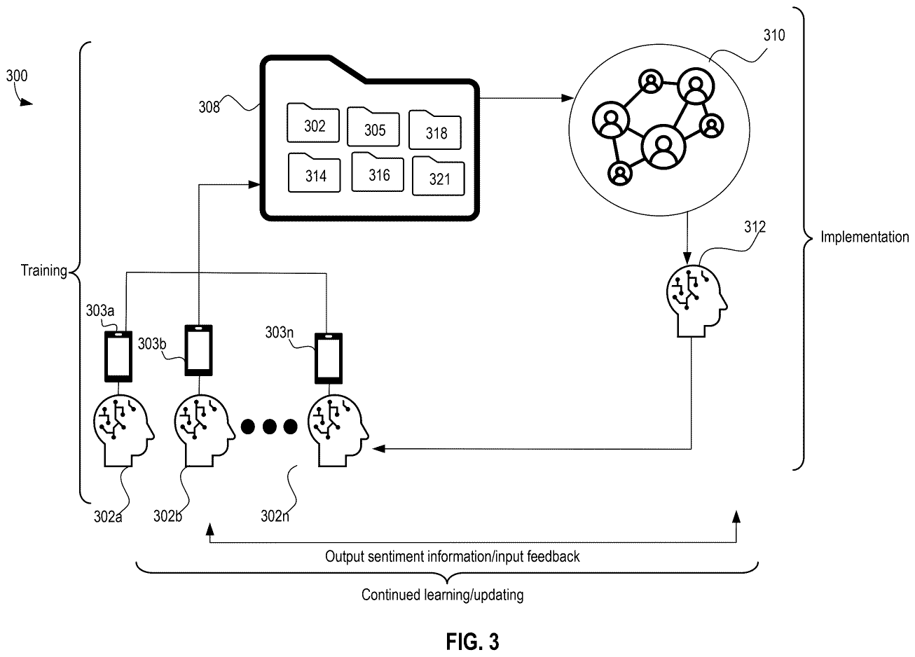

FIG. 3 illustrates an embodiment of a method of executing AI companion application in a game environment 300 using a machine learning (ML) module (e.g., an AI companion engine 310) to provide a user 302 with a generated AI companion 312. The AI companion engine 310 may be executed on a cloud-based server or the like. Each user 302 may be associated with a user device 303 that runs a local instance of an AI companion application, such as the AI companion application 154 as described with respect to FIG. 1.

According to various embodiments, a system executing the game environment 300 may launch the AI companion engine 310. In various embodiments, the game environment 300 includes an AI companion engine 310 that implements one or more machine learning operations. The one or more machine learning operations ingest one or more inputs 308 to determine long-term and short-term directives and associated actions for a generated AI companion 312 for a particular user. In some embodiments, these inputs 308 may include the user information 305 associated with each of the users 302 such as a profile associated with each user 302, corresponding metadata 314, user feedback 316, etc. In various embodiments, the one or more inputs may be gathered from social media applications 318. Other inputs 321 may include biometric information such as facial recognition technology implemented into the gaming environment such as through a user console or the like. Other inputs may include any combination of chat information, facial recognition data, time data associated with the user engaging with the game, social media information, biometric data, audio data, etc.

In at least some embodiments, the AI companion engine 310 includes a ML model configured to analyze input 308 from the user 302 in the current game and/or in other games. The AI companion engine 310 may further analyze inputs 308 from other users 302, according to some embodiments. The other users 302 may have the similar skill set as the user 302 (e.g., overlapping skills in a skill set as the user 302). In various embodiments, the ML model of the AI companion engine 310 is trained on any of the inputs 308, user information associated with the users, etc. In various embodiments, the AI companion engine 310 is trained user information of the user 302 in the current game and/or in other games. For example, the AI companion engine 310 may be trained on user data including rates of hours played, a number of players who played a game and how long they played the game, stopping points for players playing the game, etc.

The AI companion engine 310 executes various operations of process 400 described with respect to FIG. 4 below. For example, the AI companion engine 310 receive a global game directive as part of the inputs 308 from the user 302. A global game directive may establish an overarching a goal of the user for the game. For example, a global game directive may include a type of game play and/or any continuous tasks to be performed during gameplay. A global game directive may include instructions to collect each trophy, only perform required tasks within the game, complete each side quest within the game, secure each available weapon, continue the gaming session until a predetermined level or number of levels are complete, continue the gaming session for a predetermined period of time, etc. A global game directive may apply to each level or segment within the game during a gaming session. The global game directives may be received from the user via any input. In some embodiments, the user input is text input and/or audio input in the form of verbal commands or the like. Any of the foregoing information may be included in the input 308 from the user 302.

The AI companion engine 310 may further determine implicit user gameplay information based on various inputs 308. For example, the AI companion engine 310 may determine that the user is struggling (e.g., implicit user gameplay information) based on a rate of failed gameplay within a time period within the game, text data from a chat application, audio data from the user into a microphone or the like coupled to the system, biometric data such as a high heart rate and/or breath rate indicative of stress or frustration, etc. Conversely, implicit user gameplay information may indicate that the user is pleased with the AI companion and reinforce actions performed by the AI companion. Similar text data, audio data, biometric data, etc., may be used to validate and reinforce actions taken by the AI companion.

Furthermore, the AI companion engine 310 may determine short-term directives based at least in part on the implicit user gameplay information. According to various embodiments, the system may further receive short-term directives from a user 302 via the inputs 308 and/or the AI model may determine short-term directives based at least in part on the implicit user gameplay information. In various embodiments, the AI companion engine 310 generates and outputs an AI companion 312 that executes actions in accordance with the determined long-term and short-term directives of the user.

According to various embodiments, the ML model of the of the AI companion engine 310 is trained to be capable of processing natural language descriptions. The natural language training input may be part of the plurality of inputs 308. The natural language input can be processed by the ML model for generating outputs. To guide the training process, the natural language input may include ground truth information. The ground truth information may be further validated against the outputs generated by the ML model, according to various embodiments, for finding discrepancies and refining the ML model. The ML model may be iteratively refined via a feedback loop and additional training cycles.

According to various embodiments of the present disclosure, the ML model of the AI companion engine 310 may receive feedback from the user 302 for updating and training the ML model. For example, in response to the user feedback, the ML model may modify the predicted user preferences. For example, when user gameplay diverges from typical gameplay behavior, the ML model may recognize this change in behavior and adapt to accommodate new behaviors. Furthermore, the ML model may generate inquiries to determine whether the predicted user preferences are still accurate or whether the predicted user preferences need to be updated. The ML model may be updated in response to feedback and/or in response to identifying a change in user behavior. The ML model may be updated continuously and/or at predetermined intervals or as new inputs are received for training the ML model. Once the training process achieves a satisfactory level of accuracy and consistency, the ML model may be executed as part of the AI companion engine 310.

FIG. 4 is a flowchart of a method for executing an AI companion application in a game environment. Process 400 may be executed in any environment described herein and, in particular, at least system 100 as described with respect to FIG. 1. Process 400 includes block 402. Block 402 includes uploading, by a system including a processor and a memory, a game to the game environment. According to various embodiments, a CPU may execute a software module stored in main memory for uploading the game to the game environment. The game may be uploaded in a manner known in the art.

Block 404 includes launching, by the system, the AI companion application. In some embodiments, a user may send instructions to the CPU to download or otherwise launch the AI application. The AI companion application may be downloaded permanently or temporarily into memory. The AI companion application may further be accessed as part of a cloud computing game environment. The AI companion application may use one or more AI models to generate and execute an AI companion. In various embodiments, the AI companion is generated on a cloud servers and a local instance of an AI companion application will execute the AI companion (e.g., the AI companion application). According to various embodiments, an AI companion may be generated by the AI companion application in the game environment or on the cloud server. In some embodiments, the AI companion is generated on the cloud server and a local instance of the AI application executes the AI companion. The local instance of the AI companion application may have capability the revise the AI companion based on user updates and other inputs. The one or more AI models may be pretrained to generate an AI companion with basic player skills and functions. According to some embodiments, process 400 assumes an AI companion has a baseline level of training and is capable of operating within the game. For example, an AI companion may be generated on the cloud server based on historic user data which may include the user requesting the AI companion. In various embodiments, the AI companion is trained based on historic user data from all users or from a subset of users. For example, an AI companion for use in a particular game may be trained using data gathered from users playing that game. In some more specific training embodiments, the AI companion is trained by level within the game based on user data gathered from users while they play that level. The AI companion as generated on the cloud server may be continuously and/or periodically updated as new user data is available or as desired by a game developer, a user, or the like. Embodiments of the present disclosure supplement a foundational trained AI companion to provide timely feedback to a user and follow user directives within the game.

Block 406 includes receiving, by the system, a global game directive from a user. A global game directive may establish an overarching a goal of the user for the game. For example, a global game directive may include a type of game play and/or any continuous tasks to be performed during gameplay. A global game directive may include instructions to collect each trophy, only perform required tasks within the game, complete each side quest within the game, secure each available weapon, continue the gaming session until a predetermined level or number of levels are complete, continue the gaming session for a predetermined period of time, etc. A global game directive may apply to each level or segment within the game during a gaming session. The global game directives may be received from the user via any input. In some embodiments, the user input is text input and/or audio input in the form of verbal commands or the like.

The user may create and input one or more global game directives according to various embodiments. In at least some embodiments, a game developer may generate one or more global game directives for user selection. Some embodiments may include a combination of user developed and game developer developed global game directives. The user may update or otherwise add or subtract the one or more global game directives throughout the gaming session as desired. According to at least some embodiments, the one or more global game directives may be input into an AI model as a prompt for generating the AI companion that performs tasks based at least in part on the one or more global game directives. The prompt may be updated as desired by the user throughout the game. The AI companion performing the tasks may include the AI companion playing the game with a goal of achieving the tasks along with or alongside of the user.

In at least some embodiments, receiving the global game directive includes requesting the user to provide game preferences prior to engaging with a game and/or during profile creation. A global game directive may be established before engaging with the game and the user may modify the global game directive once the user starts engaging with the game, according to various embodiments. In other embodiments, a user may have preferences that apply to all games that they play, and the global game directives may be part of a profile creation process. For example, a user may input global game directives that apply to all games or types of games.

Block 408 includes executing actions, by the system via the AI companion, within the game environment in accordance with the global game directive. According to various embodiments, one or more AI models may receive inputs associated with user gameplay and determine that a user is struggling or otherwise lacking in a skill set. An action may include a suggestion to the user in various embodiments. The AI companion may proceed to predict and perform actions that further the user's global game directive. For example, an AI companion may suggest that a user use a weapon that was collected earlier in the game that may be helpful in achieving the global game directive (e.g., completing the level, earning trophies, etc.). In various embodiments, the AI model monitors user gameplay and compliments the user gameplay in areas that the user needs additional help.

Block 410 includes gathering, by the system, implicit user gameplay information from user interactions in the game environment while the AI companion executes the actions within the game environment in accordance with the global game directive. Block 410 includes analyzing the user gameplay to generate implicit user gameplay information from user interactions in the game environment. For example, block 410 may monitor a user and determine that the user has tried to complete the same challenge within the game several times. The AI model may determine that the user is struggling as implicit user gameplay information. Furthermore, implicit user gameplay information may describe that the user is struggling with a fight sequence within the challenge.

According to various embodiments, the AI companion may determine implicit user gameplay information based on various inputs. For example, the AI companion may determine that the user is struggling (e.g., implicit user gameplay information) based on a rate of failed gameplay within a time period within the game, text data from a chat application, audio data from the user into a microphone or the like coupled to the system, biometric data such as a high heart rate and/or breath rate indicative of stress or frustration, etc. Conversely, implicit user gameplay information may indicate that the user is pleased with the AI companion and reinforce actions performed by the AI companion. Similar text data, audio data, biometric data, etc., may be used to validate and reinforce actions taken by the AI companion.

Block 412 includes determining, by the system, short-term directives based at least in part on the implicit user gameplay information. Implicit user gameplay information may be gathered from one or more inputs including time data information associated with one or more titles in the game environment, shopping cart information, social media information, user search history information, etc., or any combination thereof. According to various embodiments, the system may further receive short-term directives from a user and/or the AI model may determine short-term directives based at least in part on the implicit user gameplay information. For example, a user may explicitly instruct the AI companion to go gather weapons, health, trophies, etc., for a predetermined period of time or until the user instructs the AI companion otherwise. In another example, the AI model may determine based on the implicit user gameplay information that the user is running low on game power (e.g., life) or will need certain tools (e.g., weapons). Accordingly, the AI companion will determine that a short-term directive includes gathering weapons, health, trophies, etc.

Block 414 includes modifying the actions of the AI companion based at least in part on the short-term directives. In some embodiments, the actions of the AI companion may be different for completing the global game directive and the short-term directives. According to various embodiments, the AI companion may prioritize the global game directive or the short-term directives. For example, if the global game directive is to complete the level as fast as possible but the AI companion determines that the user is low on life, the AI companion may determine that the short-term directive of collecting health to heal the user has a higher priority than other actions. In some embodiments, block 414 includes monitoring user interactions with the AI companion in the game environment and modifying the actions of the AI companion based at least in part on the monitored user interactions.

According to various embodiments, process 400 may include determining, by the system via the AI companion, a user skill based on the analyzed implicit user gameplay information. The AI companion may further determine by a complimentary skill and modify the actions of the AI companion in accordance with the complimentary skill. For example, a user skill may include offensive skills (e.g., for sports games or the like). Complimentary skills for offensive skills may include defensive skills (e.g., similarly, for sports games or the like). Pairs of skills may include, for shooter games, aiming skills and spatial skills, in some embodiments. In other embodiments, a pair of skills may include close range aiming and healing skills that complement longer range aiming skills. Accordingly, embodiments of the present disclosure include where the AI companion determines a user skill of the first user based on the analyzed implicit user gameplay information. The AI companion may then determine a complimentary skill to the user skill of the first user and perform actions in accordance with the complimentary skill. In some embodiments, the user skill includes a first tool available to the first user in the game environment (e.g., a specific weapon or power) and the complimentary skill includes a second tool available to the one or more users in the game environment (e.g., a different weapon or power).

According to various embodiments of process 400, the AI companion may request user feedback during gameplay. Requests for user feedback may be in the form of questions that confirm or otherwise validate the actions of the AI companion. For example, the AI companion may ask whether the user still wants the AI companion to proceed with an action or actions. For example, process 400 may include requesting the user feedback occurs at benchmark points within the game. Benchmark points may include a start of a level, an end of a level, before a boss section, before a challenge within the game, etc. The benchmark points may occur at at least one of in a lobby portion of the game, a pre-level point within the game, a post-level point within the game, a predetermined pivot point within the game, etc. In other embodiments, the AI companion may request user feedback at predetermined intervals during gameplay. The predetermined intervals may be set by the user and/or the game developer. The AI companion may modify its actions based on the short-term directives and the user feedback.

According to various embodiments, the system is connected to a network and the game environment is an online environment. In other embodiments, an offline environment is not connected to the network. User interactions with the AI companion may be monitored in an offline environment and the AI companion may be modified at least in part on the monitored user interactions, both online and offline.

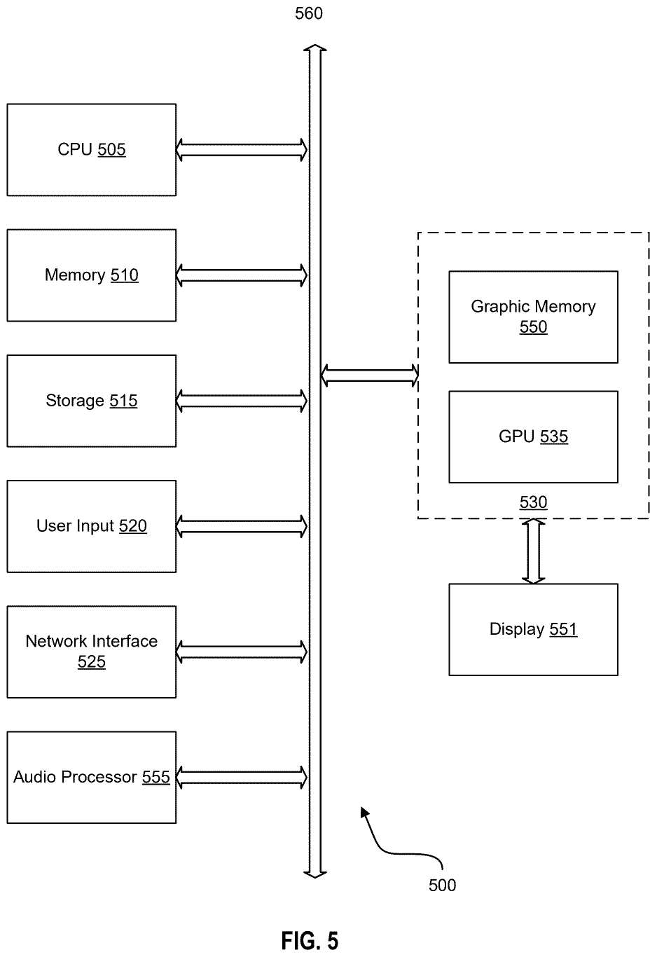

FIG. 5 illustrates an example of a hardware system suitable for implementing a computer system, according to embodiments of the present disclosure. The computer system 500 represents, for example, a video game system, a backend set of servers, or other types of a computer system. The computer system 500 includes a central processing unit (CPU) 505 for running software applications and optionally an operating system. The CPU 505 may be made up of one or more homogeneous or heterogeneous processing cores. Memory 510 stores applications and data for use by the CPU 505. Storage 515 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 520 communicate user inputs from one or more users to the computer system 500, examples of which may include keyboards, mice, thumbsticks, touch pads, touch screens, still or video cameras, and/or microphones. Network interface 525 allows the computer system 500 to communicate with other computer systems via an electronic communications network and may include wired or wireless communication over local area networks and wide area networks such as the Internet. An audio processor 555 is adapted to generate analog or digital audio output from instructions and/or data provided by the CPU 505, memory 510, and/or storage 515. The components of computer system 500, including the CPU 505, memory 510, data storage 515, user input devices 520, network interface 525, and audio processor 555 are connected via one or more data buses 560.

A graphics subsystem 530 is further connected with the data bus 560 and the components of the computer system 500. The graphics subsystem 530 includes a graphics processing unit (GPU) 535 and graphics memory 550. The graphics memory 550 includes a display memory (e.g., a frame buffer) used for storing pixel data for each pixel of an output image. The graphics memory 550 can be integrated in the same device as the GPU 535, connected as a separate device with the GPU 535, and/or implemented within the memory 510. Pixel data can be provided to the graphics memory 550 directly from the CPU 505. Alternatively, the CPU 505 provides the GPU 535 with data and/or instructions defining the desired output images, from which the GPU 535 generates the pixel data of one or more output images. The data and/or instructions defining the desired output images can be stored in the memory 510 and/or graphics memory 550. In an embodiment, the GPU 535 includes 3D rendering capabilities for generating pixel data for output images from instructions and data defining the geometry, lighting, shading, texturing, motion, and/or camera parameters for a scene. The GPU 535 can further include one or more programmable execution units capable of executing shader programs.

The graphics subsystem 530 periodically outputs pixel data for an image from the graphics memory 550 to be displayed on the display device 551. The display device 551 can be any device capable of displaying visual information in response to a signal from the computer system 500, including CRT, LCD, plasma, and OLED displays. The computer system 500 can provide the display device 551 with an analog or digital signal.

In accordance with various embodiments, the CPU 505 is one or more general-purpose microprocessors having one or more processing cores. Further embodiments can be implemented using one or more CPUs 505 with microprocessor architectures specifically adapted for highly parallel and computationally intensive applications, such as media and interactive entertainment applications.

Embodiments of the present disclosure provide systems and methods for generating an AI companion that supplements and enhances user game play. In contrast to a conventional game guide bot that provides users tips and tricks throughout the game, the AI companion as described herein takes actions that further both the long-term and short-term goals of the user during game play. Both the long-term objectives and the short-term directives may be advantageous updated by the user according to evolving goals within the game. The AI companion further verifies the directives throughout game play to ensure efficient execution and prioritization of actions. Accordingly, processing power is saved by prioritizing actions that further important directives and the AI companion does not waste efforts performing unnecessary tasks. A further advantage of the AI companion as disclosed herein is the ability to determine user skills and complimentary skills and further take actions based on the complimentary skills. Accordingly, the AI companion supplements and enhances the user experience within the game environment and particularly within the game executed within the game environment. By optimizing data processing and reducing delays, the system ensures a seamless and dynamic user experience while maintaining high performance and scalability.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of executing an AI companion application in a game environment, the method comprising:
uploading, by a system including a processor and a memory, a game to the game environment;
launching, by the system, the AI companion application;
receiving, by the system, a global game directive from a user, wherein the global game directive establishes a goal of the user for the game;
executing actions, by the system via the AI companion application, within the game environment in accordance with the global game directive;
gathering, by the system, implicit user gameplay information from user interactions in the game environment while the AI companion application executes the actions within the game environment in accordance with the global game directive;
determining, by the system, short-term directives based at least in part on the implicit user gameplay information; and
modifying the actions of the AI companion application based at least in part on the short-term directives.

2. The method of claim 1, further comprising:
requesting user feedback at at least a predetermined time intervals in the game; and
modifying the actions of the AI companion application based on the short-term directives and the user feedback.

3. The method of claim 2, wherein requesting the user feedback occurs at benchmark points within the game.

4. The method of claim 3, wherein the benchmark points occur at at least one of in a lobby portion of the game, a pre-level point within the game, a post-level point within the game, and a predetermined pivot point within the game.

5. The method of claim 1, further comprising:
determining, by the system via the AI companion application, a user skill based on the implicit user gameplay information;
determining, by the AI companion application, a complimentary skill; and
modifying the actions of the AI companion application in accordance with the complimentary skill.

6. The method of claim 5, wherein the user skill comprises an offensive skill and the complimentary skill comprises a defensive skill.

7. The method of claim 1, wherein receiving the global game directive comprises requesting the user to provide game preferences prior to engaging with a game and/or during profile creation.

8. The method of claim 1, wherein the implicit user gameplay information is gathered from one or more inputs, wherein the one or more inputs comprises time data information associated with one or more titles in the game environment, shopping cart information, social media information, and user search history information.

9. The method of claim 1, further comprising monitoring user interactions with the AI companion application in the game environment, wherein modifying the actions of the AI companion application is further based at least in part on the monitored user interactions.

10. The method of claim 9, wherein the system is connected to a network; and
further comprising, monitoring user interactions with the AI companion application in an offline environment, wherein modifying the actions of the AI companion application is further based at least in part on the monitored user interactions, wherein the offline environment is not connected to the network.

11. A system operating in a game environment, the system comprising:
one or more storage media storing instructions; and
one or more processors configured to execute the instructions causing the system to perform operations comprising:
uploading a game to the game environment;
launching an AI companion application;
receiving a global game directive from a user, wherein the global game directive establishes a goal of the user for the game;
executing actions, via the AI companion application, within the game environment in accordance with the global game directive;
gathering implicit user gameplay information from user interactions in the game environment while the AI companion application executes the actions within the game environment in accordance with the global game directive;
determining short-term directives based at least in part on the implicit user gameplay information; and
modifying the actions of the AI companion application based at least in part on the short-term directives.

12. The system of claim 11, further comprising:
requesting user feedback at at least a predetermined time intervals in the game; and
modifying the actions of the AI companion application based on the short-term directives and the user feedback.

13. The system of claim 12, wherein requesting the user feedback occurs at benchmark points within the game.

14. The system of claim 13, wherein the benchmark points occur at at least one of in a lobby portion of the game, a pre-level point within the game, a post-level point within the game, and a predetermined pivot point within the game.

15. The system of claim 11, further comprising:
determining, by the system via the AI companion application, a user skill based on the implicit user gameplay information;
determining, by the AI companion application, a complimentary skill; and
modifying the actions of the AI companion application in accordance with the complimentary skill.

16. The system of claim 15, wherein the user skill comprises an offensive skill and the complimentary skill comprises a defensive skill.

17. The system of claim 11, wherein receiving the global game directive comprises requesting the user to provide game preferences prior to engaging with a game and/or during profile creation.

18. The system of claim 11, wherein the implicit user gameplay information is gathered from one or more inputs, wherein the one or more inputs comprises time data information associated with one or more titles in the game environment, shopping cart information, social media information, and user search history information.

19. The system of claim 11, further comprising monitoring user interactions with the AI companion application in the game environment, wherein modifying the actions of the AI companion application is further based at least in part on the monitored user interactions.

20. One or more non-transitory computer-readable storage media storing instructions that, upon execution by one or more processors of a system, cause the system to:
upload a game to a game environment;
launch an AI companion application;
receive a global game directive from a user, wherein the global game directive establishes a goal of the user for the game;
execute actions, via the AI companion application, within the game environment in accordance with the global game directive;
gather implicit user gameplay information from user interactions in the game environment while the AI companion application executes the actions within the game environment in accordance with the global game directive;
determine short-term directives based at least in part on the implicit user gameplay information; and
modify the actions of the AI companion application based at least in part on the short-term directives.
